(19) United States
(12) Patent Application Publication
(10) Pub. No.: US 2017/0267065 A1
(43) Pub. Date: Sep. 21, 2017

(54) AIR CONDITIONING SYSTEM FOR VEHICLE

(71) Applicants: Hyundai Motor Company, Seoul (KR); Kia Motors Corporation, Seoul (KR); Hanon Systems, Daejeon (KR)

(72) Inventors: Myung Hoe KIM, Seoul (KR); Sun Dong KIM, Suwon-si (KR); Young Soo NAM, Gaepo-myeon (KR); Byeong Moo JANG, Suwon-si (KR); Jong Sik BAE, Suwon-si (KR); Moo Yong KIM, Suwon-si (KR); Jeong Hun SEO, Daejeon (KR); Tae Wan KIM, Daejeon (KR); Yong Eun SEO, Daejeon (KR)

(73) Assignees: Hyundai Motor Company, Seoul (KR); Kia Motors Corporation, Seoul (KR); Hanon Systems, Daejeon (KR)

(21) Appl. No.: 15/284,401

(22) Filed: Oct. 3, 2016

(30) Foreign Application Priority Data
Mar. 16, 2016 (KR) 10-2016-0031662

(51) Int. Cl. B60H 1/24; B60H 1/00

(52) U.S. Cl. CPC B60H 1/244; B60H 1/00564; B60H 2001/002; B60H 2001/00192; B60H 2001/00721

(57) ABSTRACT

An air conditioning system for a vehicle may include a front Heating, Ventilation, and Air Conditioning (HVAC), a rear extension duct for supplying air from the front HVAC to a rear seat, a rear blower disposed in a middle of the rear extension duct to blow air drawn in through the rear extension duct from the front HVAC, a vent duct branched from the rear extension duct to discharge air blown by the rear blower to a rear interior space of the vehicle through a vent grille, a rear floor duct branched from the vent duct to discharge air supplied through the vent duct to the rear interior space, and an air direction adjustment door to adjust a direction of air and a volume of the air for the vent duct extending to the vent grille and the rear floor duct extending to the discharge port, and an actuator thereof.

### CROSS-REFERENCE TO RELATED APPLICATION

The present application claims priority to Korean Patent Application No. 10-2016-0031662, filed Mar. 16, 2016, the entire contents of which is incorporated herein for all purposes by this reference.

### BACKGROUND OF THE INVENTION

Field of the Invention

Various aspects of the present invention relate to an air conditioning system for a vehicle. More particularly, to an air conditioning system for a vehicle, capable of individually controlling air conditioning for a rear seat.

Description of Related Art

As known in the art, vehicles are equipped with Heating, Ventilation, and Air Conditioning systems (HVACs) for regulating interior temperatures and creating pleasant indoor environments.

In addition, most vehicles have been recently equipped with Full Automatic Temperature Control (FATC) systems for automatically regulating interior temperatures according to the temperatures set by drivers or passengers in order to maintain pleasant interior environments.

When a user sets a temperature using such a FATC system, an air conditioning controller calculates an interior thermal load using information such as a quantity of solar radiation, an outside air temperature, and an interior temperature detected by sensors in order for the interior temperature to be controlled to a set temperature, and the controller determines a discharge mode, a discharge temperature, a discharge direction, a volume of discharged air, etc. in consideration of an air conditioning load corresponding to the calculated thermal load.

The air conditioning controller controls operation elements, such as an actuator for each of an air intake door (an inside/outside air switching door), a temperature door (a temperature regulation door), an air direction adjustment door (a mode door), and the like, an air conditioning blower, an air conditioning compressor, and an electric heater, in order to control the supply of air-conditioned air according to the determined discharge mode, discharge temperature, discharge direction, and volume of discharged air.

In addition, air conditioning modes in an air conditioning system for a vehicle are classified into various modes according to air introduction and discharge methods. For example, the air conditioning modes are classified into an outside air mode, an inside air mode, etc., according to air introduction methods, and the air conditioning system includes an air intake door for controlling the inside/outside air mode, and an actuator thereof.

The air conditioning modes are classified into a face mode (or called a vent mode), a floor (FLR) mode, a defrost (DEF) mode, a bi-level mode, etc. according to air discharge methods. To this end, the air conditioning system includes an air direction adjustment door for changing the flow path of air according to each mode, and a vent door installed at the inlet of each vent to open and close the vent.

The vents of the air conditioning system are classified into a face vent for discharging air toward the user's face and chest, a floor vent for discharging air toward the vehicle floor and driver's feet, and a defrost vent for discharging air toward the windshield glass of the vehicle, etc., and the vent door is installed at the inlet of each vent to open and close the associated vent according to air conditioning modes.

Meanwhile, the vehicle has been recently equipped with an air conditioning system which may divide an interior space into a plurality of zones to perform air conditioning for each zone. For example, there is known a three-zone type air conditioning system which performs air conditioning for driver and passenger seats as front seats and for a two-row rear seat by a front HVAC.

In the air conditioning system, air-conditioned air is discharged toward the driver and passenger seats through vents provided on a dash panel, and air-conditioned air is discharged toward the rear seat through a console vent formed on the rear surface of a console box.

In addition, a recent luxury vehicle is additionally provided with a center pillar vent and a rear floor discharge port in addition to a console vent in order to improve cooling/heating performance for a rear space.

The conventional three-zone type air conditioning system may control both the direction of air and the volume of air together with temperature control for the front seats (driver and passenger seats). However, the conventional three-zone type air conditioning system may control temperature, but may not control the direction of air and the volume of air for the rear seat.

In addition, the three-zone type air conditioning system is mainly applied to large vehicles. However, since air is supplied to the rear seat using the air conditioning blower of the front HVAC, air volume may be insufficient in the rear seat and there is a limit in increasing the air volume for the rear seat.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an improved air conditioning system for a vehicle, capable of individually controlling air conditioning for a rear seat independently of front seats.

Additionally, various aspects of the present invention are directed to providing an air conditioning system for a vehicle, capable of controlling the direction of air to a rear seat independently of front seats, and selectively controlling the direction of air to a console vent, a center pillar vent, and a rear floor discharge port, and controlling modes (e.g., an air direction) for the rear seat independently of mode control for the front seats.

Furthermore, various aspects of the present invention are directed to providing an air conditioning system for a vehicle, capable of controlling the volume of air in a rear seat independently of front seats, and individually controlling each of the volume and distribution of air at a console vent, a center pillar vent, and a rear floor discharge port, and improving insufficient air volume in the rear seat.

According to various aspects of the present invention, an air conditioning system for a vehicle, may include a front HVAC to perform air conditioning of a front seat of a vehicle, a rear extension duct for supplying air from the front HVAC to a rear seat, a rear blower disposed in a middle of the rear extension duct to blow air drawn in through the rear extension duct from the front HVAC, a vent duct branched from the rear extension duct to discharge air blown by the rear blower to a rear interior space of the vehicle through a vent grille, a rear floor duct branched from the vent duct to discharge air supplied through the vent duct to the rear interior space through a discharge port, and an air direction adjustment door to adjust a direction of air and a volume of the air for the vent duct extending to the vent grille and the rear floor duct extending to the discharge port, and an actuator of the air direction adjustment door.

The vent duct may include a connection duct branched from the rear extension duct, a mode duct connected to the connection duct while the rear floor duct is branched from the mode duct, and a main duct connected to the mode duct and extending to the vent grille, and the air direction adjustment door may be disposed in the mode duct, to selectively open and close an inlet of the main duct and an inlet of the rear floor duct or adjust degrees of opening of the inlet of the main duct and the inlet of the rear floor duct.

The vent duct may be a center pillar vent duct branched from the rear extension duct to extend toward a center pillar, and a center pillar vent grille located at the center pillar may be disposed at an end of the center pillar vent duct.

The center pillar vent duct may include a connection duct branched from the rear extension duct, a mode duct connected to the connection duct while the rear floor duct is branched from the mode duct, and a center pillar main duct connected to the mode duct and extending to the center pillar vent grille, and the air direction adjustment door may be disposed in the mode duct, to selectively open and close an inlet of the center pillar main duct and an inlet of the rear floor duct or adjust degrees of opening of the inlet of the center pillar main duct and the inlet of the rear floor duct.

The rear extension duct may be a console vent duct extending to a console box from the front HVAC, a console vent grille being disposed at an end of the console vent duct.

The vent duct may be a center pillar vent duct branched from the console vent duct to extend toward a center pillar, and a center pillar vent grille located at the center pillar may be disposed at an end of the center pillar vent duct.

The center pillar vent duct may include a connection duct branched from the console vent duct, a mode duct connected to the connection duct while the rear floor duct is branched from the mode duct, and a center pillar main duct connected to the mode duct and extending to the center pillar vent grille, and the air direction adjustment door may be disposed in the mode duct, to selectively open and close an inlet of the center pillar main duct and an inlet of the rear floor duct or adjust degrees of opening of the inlet of the center pillar main duct and the inlet of the rear floor duct.

In a vent mode for the rear seat in which air is discharged through the console vent grille and the center pillar vent grille, an air conditioning controller may be configured to control a position of the air direction adjustment door such that the air direction adjustment door closes the inlet of the rear floor duct and opens the inlet of the center pillar main duct.

In a bi-level mode in which air is discharged through the console vent grille, the center pillar vent grille, and the discharge port of the rear floor duct, an air conditioning controller may be configured to control a position of the air direction adjustment door such that the air direction adjustment door opens both of the inlet of the rear floor duct and the inlet of the center pillar main duct.

In a floor mode in which air is discharged through the discharge port of the rear floor duct, an air conditioning controller may be configured to control a position of the air direction adjustment door such that the air direction adjustment door closes the inlet of the center pillar main duct and opens the inlet of the rear floor duct in a state in which the console vent grille is closed by a door at an inlet of the console vent grille.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating supply of air to a rear seat and a discharge structure in a conventional three-zone type air conditioning system.

FIG. 2 is a top view illustrating an air conditioning system for a vehicle according to various embodiments of the present invention.

FIG. 3 is a view illustrating a mode duct and an air direction adjustment door in the air conditioning system for a vehicle according to various embodiments of the present invention.

FIG. 4 is a view illustrating a position of the air direction adjustment door in a bi-level mode for a rear seat in the air conditioning system for a vehicle according to various embodiments of the present invention.

FIG. 5 is a view illustrating a position of the air direction adjustment door in a floor mode for the rear seat in the air conditioning system for a vehicle according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

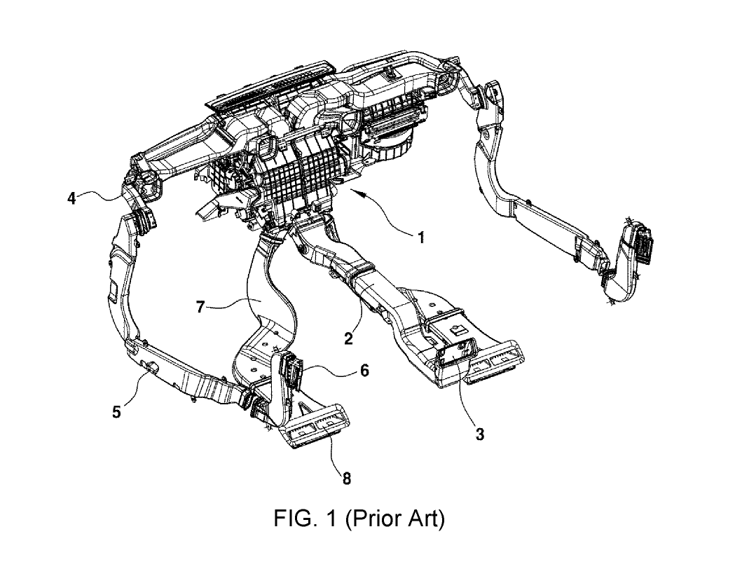

First, a configuration of a known three-zone type air conditioning system will be described with reference to FIG. 1 for a comparison with the configuration of the present invention.

FIG. 1 is a view schematically illustrating the supply of air to a rear seat using a front HVAC and a discharge structure, and a combination example of a console vent, a center pillar vent, and a rear floor discharge port.

As illustrated in the drawing, in the known three-zone type air conditioning system, when air is blown by an air conditioning blower of a front HVAC 1, air is supplied through a console vent duct 2 which is connected to a console box from the central portion of the lower end of the HVAC, and the air supplied through the console vent duct 2 is discharged to the central portion of a rear seat through a console vent grille 3.

In addition, when air is supplied through center pillar vent ducts 5 which are connected to both left and right side connection ducts 4 of the HVAC 1 to extend inward of a center pillar (a B pillar), the air is discharged to both spaces in the rear seat through center pillar vent grilles 6 (located in the center pillar) installed at the ends of the center pillar vent ducts 5.

In addition, when air is supplied through rear floor ducts 7 which extend to a rear floor from both sides of the lower end of the HVAC 1, the air is discharged to the space in the rear floor through each rear floor discharge port 8.

The air conditioning system may control both the direction of air and the volume of air together with temperature control for front seats (driver and passenger seats). However, the air conditioning system may control temperature, but may not control the direction of air and the volume of air for the rear seat.

In more detail, the conventional three-zone type air conditioning system may distribute air-conditioned air (air for cooling/heating) to the rear seat using the front HVAC, but does not have a separate mechanism for selectively controlling the direction of air to the console vent, the center pillar vent, and the rear floor discharge port.

In particular, it is impossible to selectively realize and control modes for the rear seat, i.e. a face mode (a vent mode), a floor mode, and a bi-level mode, independently of mode control for the front seats.

Accordingly, the direction and distribution of air in the modes for the rear seat are determined according to the set mode in the front HVAC. When the modes for the rear seat are to be changed, the modes for the front seats should also be changed together.

In addition, the mechanism for controlling the volume of air in the rear seat independently of the front seats is not present. Accordingly, when the volume of air in the rear seat is changed, the volume of air in the front seats is changed together. For this reason, it is impossible to individually control each of the volume and distribution of air at the console vent, the center pillar vent, and the rear floor discharge port.

In addition, since air is supplied to the rear seat using the air conditioning blower of the front HVAC, air volume may be insufficient in the rear seat and there is a limit in increasing the air volume for the rear seat.

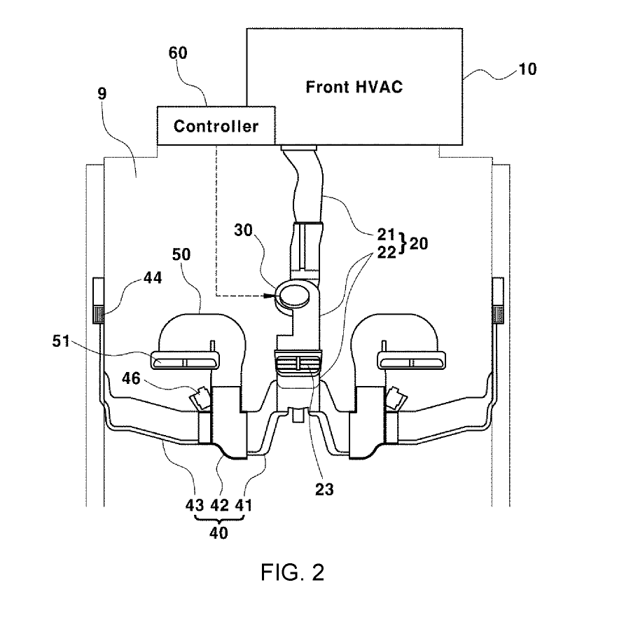

Various embodiments of the present invention are directed to solving the problem relating to the known three-zone type air conditioning system, and the various embodiments will be described with reference to FIGS. 2 to 5.

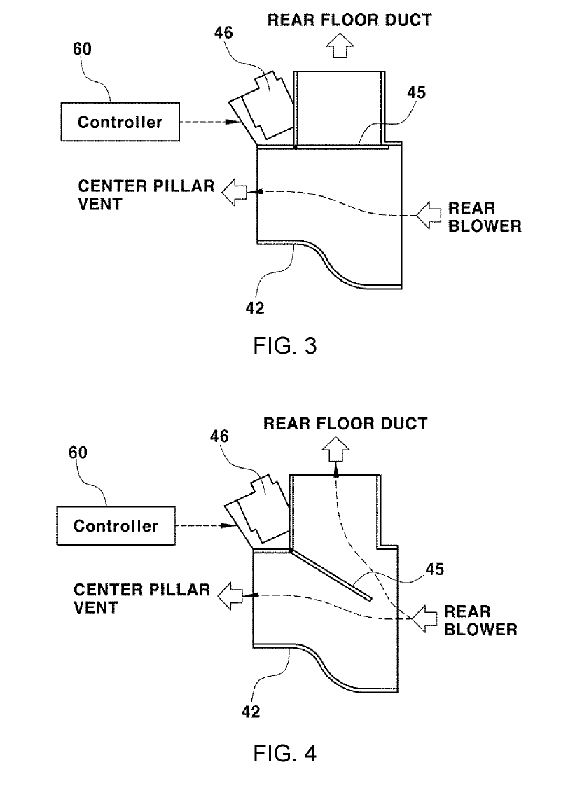

FIG. 2 is a top view illustrating an air conditioning system for a vehicle according to various embodiments of the present invention. FIG. 3 is a view illustrating a mode duct and an air direction adjustment door in the air conditioning system for a vehicle according to various embodiments of the present invention.

Reference numeral 9 refers to a floor panel of a vehicle.

First, the basic configuration of a front HVAC 10 to perform air conditioning for front seats of the vehicle, i.e. a driver seat and a passenger seat is identical to that of the known HVAC.

For example, the front HVAC 10 may include an air conditioning blower unit, an air conditioning case, an evaporator and a heater core in the air conditioning case, an inside/outside air introduction port of the air conditioning blower unit, an air intake door (an inside/outside air switching door) and an actuator thereof, and a temperature door (a temperature regulation door) and an actuator thereof.

In addition, the front HVAC 10 includes an air direction adjustment door (a mode door) which changes the flow path of air according to each of a face mode (a vent mode), a floor mode, a defrost mode, and a bi-level mode for the front seats, and an actuator thereof.

In addition, in order to discharge air toward a front interior space of the vehicle, the front HVAC 10 has a face vent for discharging air toward the user's face and chest, a floor vent for discharging air toward the vehicle floor and driver's feet, a defrost vent for discharging air toward the windshield glass of the vehicle, etc.

The front HVAC 10 may perform temperature control, air direction control, and air volume control for the driver and passenger seats of the vehicle.

Meanwhile, a console vent duct 20 is installed so as to extend to a console box from the central portion of the lower end of the front HVAC 10, and a console vent grille 23 is installed at the end of the console vent duct 20 while being located on the rear surface of the console box.

The console vent duct 20 is a rear extension duct for supplying air-conditioned air (air for cooling/heating), which is blown by the air conditioning blower of the front HVAC 10, to the rear seat, and a rear blower unit 30 is installed in the middle of the console vent duct 20.

The rear blower unit 30 includes a blower case, and a rear blower included in the blower case, which are not illustrated in the drawing.

The inlet portion of the blower case of the rear blower unit 30 is connected to the outlet of the rear end of a front console vent duct 21 extending from the front HVAC 10, and the outlet of the blower case is connected to the inlet of a rear console vent duct 22, the end of which is provided with the console vent grille 23.

The rear blower serves to draw in air discharged from the front HVAC 10 and supply the air to the rear seat. When the rear blower is driven, it draws in air from the front HVAC 10 through the front console vent duct 21 and blows the air through the rear console vent duct 22.

Similar to the air conditioning blower of the front HVAC 10, an air conditioning controller controls an operation voltage applied to a blower motor so as to regulate the rotation speed of the rear blower and the volume of air blown from the rear blower.

In addition, the volume of air supplied to the rear seat may be controlled by controlling the driving of the rear blower, i.e. by controlling the rotation speed of the rear blower and the volume of air blown from the rear blower.

It is possible to improve the lack of air volume in the rear seat by additionally installing the separate rear blower to blow air drawn in from the front HVAC 10 toward the rear seat, and to increase the volume of air in the rear seat compared to the conventional three-zone type air conditioning system.

Through the above configuration, when the air-conditioned air blown by the air conditioning blower is supplied to the console vent duct 20 through the central portion of the lower end of the front HVAC 10, and the air, which is drawn in to the rear blower from the front HVAC 10 through the console vent duct 20, is simultaneously blown, the air blown by the rear blower may be discharged to a rear interior space through the console vent grille 23.

Meanwhile, the air conditioning system according to various embodiments of the present invention includes center pillar vent ducts 40 which are branched to left and right sides from the console vent duct 20, particularly from the console vent duct 22 at the rear end (the downstream side) of the rear blower.

The center pillar vent ducts 40 are vent ducts which are branched from the rear extension duct, i.e. the console vent duct 20 to discharge air blown by the rear blower to the rear space.

In addition, each of both left and right center pillar vent ducts 40 includes a mode duct 42 which is installed in the middle thereof for connection with another duct.

In addition, center pillar main ducts 43 branched from the respective mode ducts 42 extend to left and right center pillars, and center pillar vent grilles 44 are installed at the ends of the center pillar main ducts 43 while being located at the center pillars (the B pillars).

Hereinafter, the section, which is connected to the mode duct 42 in the entire section of each of the center pillar vent ducts 40 branched to left and right sides from the console vent duct 20, will be referred to as a connection duct 41.

In addition, the section, which is branched from the mode duct 42 to extend inward of the associated center pillar, will be referred to as a center pillar main duct 43.

Accordingly, the center pillar vent ducts 40 are ducts branched to left and right sides from the console vent duct 20, and each of the center pillar vent ducts 40 includes the connection duct 41, the mode duct 42, and the center pillar main duct 43 as the remaining section thereof.

Each of the mode ducts 42 is connected to a rear floor duct 50 in addition to the center pillar main duct 43. As a result, the center pillar main duct 43 and the rear floor duct 50 are branched from the mode duct 42.

Since the rear floor duct 50 is a duct branched from the mode duct 42 and the mode duct 42 is a constituent duct of the center pillar vent duct 40, the rear floor duct 50 may be a duct branched from the center pillar vent duct 40.

In addition, each of the mode ducts 42 is provided therein with an air direction adjustment door 45 which selectively opens and closes the inlets of the center pillar main duct 43 and the rear floor duct 50 and adjusts the degrees of opening of the inlets, and the air direction adjustment door 45 is operated by an actuator 46.

In addition, the driving of the actuator 46 is controlled by the air conditioning controller, and the position of the air direction adjustment door 45 is adjusted by controlling the driving of the actuator 46. Thus, the inlets of the center pillar main duct 43 and the rear floor duct 50 may be perfectly opened or closed and the degrees of opening thereof may be adjusted.

That is, the direction of air to the center pillar main duct 43 and the rear floor duct 50 may be selectively controlled by the air direction adjustment door 45, and the volume of air in each of ducts 43 and 50 may be controlled. It is possible to adjust the distribution of air discharged through the center pillar vent grille 44 and the rear floor discharge port 51 by controlling the position of the air direction adjustment door 45.

The process of discharging air through the center pillar vent grille 44 and the rear floor discharge port 51 will be described. When air blown from the front HVAC 10 by the air conditioning blower is supplied to the console vent duct 20, and the rear blower is simultaneously driven, the air drawn in from the front HVAC 10 through the console vent duct 20 is discharged.

In addition, after air blown by the rear blower is discharged from the console vent duct 20 to the connection duct 41 and the mode duct 42, the air is distributed from the mode duct 42 to the center pillar main duct 43, and the air distributed to the center pillar main duct 43 is finally discharged through the center pillar vent grille 44.

In addition, the air distributed from the mode duct 42 to the rear floor duct 50 is finally discharged through the rear floor discharge port 51.

The rear floor duct 50 may have a shape that extends forward from each of the left and right mode ducts 42 and is then bent to extend rearward, as illustrated in FIG. 2. The rear floor discharge port 51 for discharging air to the rear space is formed at the end of the rear extension portion of the rear floor duct 50,

The configuration of the air conditioning system according to various embodiments of the present invention has been described, and the air conditioning control for each mode in the rear seat will be described below.

Since air, the temperature of which is regulated, is basically supplied and discharged from the front HVAC 10 to the rear seat, the temperature in the rear seat may be controlled, and the direction and volume of air for the rear seat may be individually controlled.

First, in the vent mode for the rear seat, air is discharged through the console vent grille 23 and the center pillar vent grille 44.

In this case, the rear blower is driven, and the position of the air direction adjustment door 45 in the mode duct 42 is controlled in order to close the inlet of the rear floor duct 50 and open the inlet of the center pillar main duct 43, as illustrated in FIG. 3.

Thus, air is supplied to the front HVAC 10, the front console vent duct 21, the rear blower, the rear console vent duct 22, and the console vent grille 23 in this order, and is finally discharged from the console vent grille 23.

At the same time, air is supplied to the front HVAC 10, the front console vent duct 21, the rear blower, the rear console vent duct 22, the connection duct 41, the mode duct 42, the center pillar main duct 43, and the center pillar vent grille 44 in this order, and is finally discharged from the center pillar vent grille 44.

In this case, since the inlet of the rear floor duct 50 is closed by the air direction adjustment door 45, air is not discharged through the rear floor discharge port 51.

Next, in the bi-level mode for the rear seat, air is discharged through all of the console vent grille 23, the center pillar vent grille 44, and the rear floor discharge port 51.

FIG. 4 is a view illustrating the position of the air direction adjustment door 45 in the bi-level mode for the rear seat. As illustrated in the drawing, the position of the air direction adjustment door 45 is controlled in order to open both of the inlet of the center pillar main duct 43 and the inlet of the rear floor duct 50. In this case, the distribution of air to the center pillar main duct 43 and the rear floor duct 50 is adjusted according a set value.

There is no difference in the flow of air discharged from the console vent grille 23 and the center pillar vent grille 44 between the bi-level mode and the vent mode for the rear seat. However, air is supplied to the front HVAC 10, the front console vent duct 21, the rear blower, the rear console vent duct 22, the connection duct 41, the mode duct 42, the rear floor duct 50, and the rear floor discharge port 51 in this order, and is finally discharged from the rear floor discharge port 51.

Next, in the floor mode for the rear seat, air is discharged only through the rear floor discharge port 51.

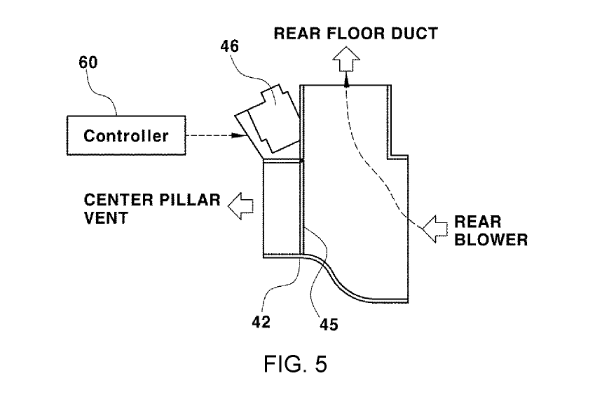

FIG. 5 is a view illustrating the position of the air direction adjustment door 45 in the floor mode for the rear seat. As illustrated in the drawing, the position of the air direction adjustment door 45 is controlled in order to close the inlet of the center pillar main duct 43 and open the inlet of the rear floor duct 50.

In addition, when the console vent grille is closed using the door installed at the inlet of the console vent grille 23 in the rear console vent duct 22, air is not discharged through the console vent grille.

As a result, air is supplied to the front HVAC 10, the front console vent duct 21, the rear blower, the rear console vent duct 22, the connection duct 41, the mode duct 42, the rear floor duct 50, and the rear floor discharge port 51 in this order, and is finally discharged only from the rear floor discharge port 51.

Through such a configuration, it is possible to improve air conditioning control and comfort of the rear seat, compared to the conventional three-zone type air conditioning system.

In particular, it is possible to control the direction of air to the rear seat for each mode, to individually control the volume of air for the rear seat by controlling the rear blower, and to individually control the volume and distribution of air at the console vent, the center pillar vent, and the rear floor discharge port.

In addition, it is possible to improve a problem of insufficient air volume in the rear seat by additionally installing the separate rear blower to blow air drawn in from the front HVAC toward the rear seat, and to improve cooling/heating performance for the rear seat since the volume of air in the rear seat is increased compared to the conventional three-zone type air conditioning system.

Of course, the cooling/heating for the rear seat may be performed by additionally installing a separate HVAC for the rear seat in the vehicle, i.e., additionally installing a dedicated rear HVAC operated independently of the front seats of the vehicle. However, since the dedicated rear HVAC requires a separate air conditioning case, a separate evaporator, a heater core, etc., in addition to the rear blower, manufacturing costs may be largely increased. In addition, since the dedicated rear HVAC requires an additional installation space, the storage space such as a console or a trunk may be reduced.

As is apparent from the above description, in accordance with an air conditioning system for a vehicle of various embodiments of the present invention, it is possible to improve air conditioning control and comfort of a rear seat, compared to a conventional three-zone type air conditioning system.

In particular, it is possible to control the direction of air to the rear seat for each mode, to individually control the volume of air for the rear seat by controlling a rear blower, and to individually control the volume and distribution of air at a console vent, a center pillar vent, and a rear floor discharge port.

In addition, it is possible to improve a problem of insufficient air volume in the rear seat by additionally installing a separate rear blower to blow air drawn in from a front HVAC toward the rear seat, and to improve cooling/heating performance for the rear seat since the volume of air in the rear seat is increased compared to the conventional three-zone type air conditioning system.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air conditioning system for a vehicle, comprising:
a front Heating, Ventilation, and Air Conditioning (HVAC) to perform air conditioning of a front seat of the vehicle;
a rear extension duct for supplying air from the front HVAC to a rear seat;
a rear blower disposed in a middle of the rear extension duct to blow air drawn in through the rear extension duct from the front HVAC;
a vent duct branched from the rear extension duct to discharge air blown by the rear blower to a rear interior space of the vehicle through a vent grille;
a rear floor duct branched from the vent duct to discharge air supplied through the vent duct to the rear interior space through a discharge port;
an air direction adjustment door to adjust a direction of air and a volume of the air for the vent duct extending to the vent grille and the rear floor duct extending to the discharge port; and
an actuator of the air direction adjustment door.

2. The air conditioning system of claim 1, wherein the vent duct comprises:
a connection duct branched from the rear extension duct;
a mode duct connected to the connection duct while the rear floor duct is branched from the mode duct; and
a main duct connected to the mode duct and extending to the vent grille, and
wherein the air direction adjustment door is disposed in the mode duct, to selectively open and close an inlet of the main duct and an inlet of the rear floor duct or adjust degrees of opening of the inlet of the main duct and the inlet of the rear floor duct.

3. The air conditioning system of claim 1, wherein the vent duct is a center pillar vent duct branched from the rear extension duct to extend toward a center pillar, and a center pillar vent grille located at the center pillar is disposed at an end of the center pillar vent duct.

4. The air conditioning system of claim 3, wherein the center pillar vent duct comprises:
a connection duct branched from the rear extension duct;
a mode duct connected to the connection duct while the rear floor duct is branched from the mode duct; and
a center pillar main duct connected to the mode duct and extending to the center pillar vent grille, and
wherein the air direction adjustment door is disposed in the mode duct, to selectively open and close an inlet of the center pillar main duct and an inlet of the rear floor duct or adjust degrees of opening of the inlet of the center pillar main duct and the inlet of the rear floor duct.

5. The air conditioning system of claim 1, wherein the rear extension duct comprises a console vent duct extending to a console box from the front HVAC, a console vent grille being disposed at an end of the console vent duct.

6. The air conditioning system of claim 5, wherein the vent duct comprises a center pillar vent duct branched from the console vent duct to extend toward a center pillar, and a center pillar vent grille located at the center pillar is disposed at an end of the center pillar vent duct.

7. The air conditioning system of claim 6, wherein the center pillar vent duct comprises:
a connection duct branched from the console vent duct;
a mode duct connected to the connection duct while the rear floor duct is branched from the mode duct; and
a center pillar main duct connected to the mode duct and extending to the center pillar vent grille, and
wherein the air direction adjustment door is disposed in the mode duct, to selectively open and close an inlet of the center pillar main duct and an inlet of the rear floor duct or adjust degrees of opening of the inlet of the center pillar main duct and the inlet of the rear floor duct.

8. The air conditioning system of claim 7, wherein, in a vent mode for the rear seat in which air is discharged through the console vent grille and the center pillar vent grille, an air conditioning controller is configured to control a position of the air direction adjustment door such that the air direction adjustment door closes the inlet of the rear floor duct and opens the inlet of the center pillar main duct.

9. The air conditioning system of claim 7, wherein, in a bi-level mode in which air is discharged through the console vent grille, the center pillar vent grille, and the discharge port of the rear floor duct, an air conditioning controller is configured to control a position of the air direction adjustment door such that the air direction adjustment door opens both of the inlet of the rear floor duct and the inlet of the center pillar main duct.

10. The air conditioning system of claim 7, wherein, in a floor mode in which air is discharged through the discharge port of the rear floor duct, an air conditioning controller is configured to control a position of the air direction adjustment door such that the air direction adjustment door closes the inlet of the center pillar main duct and opens the inlet of the rear floor duct in a state in which the console vent grille is closed by a door at an inlet of the console vent grille.
